(19) United States
(12) Patent Application Publication
(10) Pub. No.: US 2020/0160464 A1
(43) Pub. Date: May 21, 2020

(54) SYSTEM FOR COLLABORATIVE INFRASTRUCTURE MANAGEMENT AND INCIDENT RESPONSE

(71) Applicant: EUTECH CYBERNETIC PTE LTD, Singapore (SG)

(72) Inventors: Bandu WEWALAARACHCHI, Singapore (SG); Haritharan GUNASINGHAM, Singapore (SG); Haran SHIVANAN, Colombo (LK); Madiha RASOOL, Dubai (AE)

(21) Appl. No.: 16/627,452

(22) PCT Filed: Jun. 27, 2018
(86) PCT No.: PCT/SG2018/050311

§ 371 Date: Dec. 30, 2019

(30) Foreign Application Priority Data
Jun. 30, 2017 (SG) 10201705373P

(51) Int. Cl. G06Q 50/16; G06F 16/951; G06F 16/41; G06Q 10/10

(52) U.S. Cl. CPC G06Q 50/163; G06Q 10/103; G06F 16/41; G06F 16/951

(57) ABSTRACT

A method and system for facility management, technicians, security, tenants, visitors and other occupants of the space to collaborate on matters relevant to management, operation, safety and repair of the facility. The system includes a mobile app installed on the mobile devices of a plurality of facility occupants which allows the facility occupants to communicate and collaborate with one-another concerning issues concerning the facility. A collaboration server coordinates communications between users, facility managers and facility management system software via translation scripts.

### BACKGROUND OF THE INVENTION

### Field of the Invention

This invention relates to the field of smart infrastructure.

### Description of the Background

Conventional building management, asset management, space management and facility management systems (referred as facility management systems hereafter) are meant to operate with two important goals:
a) Efficient ‘resource management’ in providing services (i.e., equipment maintenance and/or repair; emergency response, etc) to end-users.
b) Making sure end-users are satisfied with the service levels provided.

The primary users of the facility management systems software are building operators, facility managers and technicians who are either coordinating the services or providing the services.

In some cases, the actual service is provided by external contractors.

Typical Service Request

When a Tenant of a shopping mall (end-user) makes a request for a facility management service such as an equipment repair, facility management personnel will initiate a transaction in the facility management system. Then, a supervisor will allocate a technician who is qualified to handle the type of repair, and schedule the job based on the availability calendar. After the job is done, additional information such as time taken to do the work, spare parts used, etc. are recorded in the system for the purpose of costing and analysis.

One of the fundamental requirements of an effective facility management system is its ability to automate backend tasks. In the example above, as soon as the transaction is created in the system, the system may automatically assign an appropriate technician and/or notify the assigned technician via SMS or email.

Limitations in End-User Engagement

Conventional facility management systems are unable to extend their access to end-users, Tenants of the mall in above example, due to the following primary limitations.

Mandatory Information for Work Order

Facility management systems require adequate information about the Work Order in order to begin its automated workflow.

In the above example (i.e., tenant request for equipment repair), accurate understanding of the ‘equipment’ that needs repair is very important, because it determines the location where technician must go to perform the work. Also, the nature of the problem needs to be correctly identified in order to select a technician with the appropriate skills. In the case of air-conditioning equipment failure, the cause could be a failure of the electrical supply, or a failure of the device itself, which relate to two different skill sets. Further, understanding the severity of the problem is important in determining the priority of the work. Tenants are often not in a position to know much of the required information except for the symptom, i.e., there's a leak, or the space is too cold, etc.

Technical Jargon

The nomenclature used in facility management system software may present ambiguity from the end-user's perspective. The term ‘severity’ in the above example is meant to identify the severity with respect to everything happening in the mall to help the facility management system determine which job can be postponed to take up space for this job. However, when a specific Tenant is asked to identify the severity of an issue/problem, the Tenant is likely to assign a much different severity than would facility management who is responsible for managing a much larger space than that occupied by the Tenant.

Similarly, facility management systems may ask the end-user (the Tenant in this example) to choose the right equipment from a list, which could be complex because as far as the Tenant is concerned, there is only one ‘air conditioning system’ that he/she is concerned about, although it is made up of a collection of equipment in facility management systems.

Information Privacy

The database of facility management systems containing information about people and work history belongs to the software licensee—the Shopping Mall in this case. However, actual services may be provided by external parties, who are operating under subcontractor agreements where rules of information privacy are enforced.

When the facility management system is extended beyond the employees and subcontractors of the licensee, it is not possible to enforce information privacy because the ‘customer of licensee’ (Tenant in the above example) is not bound by such terms. It is unlikely that such ‘customer’ would agree to an extensive agreement just for the purpose of ‘assisting’ the facility management team to provide the services that are obligatory as part of the tenancy agreement.

The situation becomes completely untenable when the end-users are ‘shoppers of the mall’ or ‘guests of the office.’

Licensing Costs

In most situations, the license cost of the facility management systems increases when it is extended to additional users. In the above example, the Mall may have a staff of 25 who would need direct access to the facility management systems however; if access to the facility management system were to be extended to all Tenants, the number of users would rise to 500 or more.

Requirement for Progressive Data Collection—Conversation

As a result, there is a requirement to collect necessary information progressively before a formal transaction (referred as Work Order hereafter) can be created in the facility management systems.

In the example mentioned above (Tenant request for equipment repair), the Tenant would typically call someone with facility management and explain the problem. In this case if the same Tenant has multiple shops in the mall, the service coordinator may ask the Tenant to identify the location of the problem. To describe the problem better, the coordinator may ask the Tenant to send a photograph of the equipment—or to scan a barcode printed on the equipment with a smartphone. This is a ‘conversation’.

As this conversation progresses, a person with technical background would join the conversation, and may ask further questions to accurately understand the skills required to address the problem and the severity of the problem.

At this point, one of the members participating in the conversation might create a Work Order in the facility management systems with the necessary information for the automated workflow to kick in.

Requirement to Collaborate

As stipulated at the start, one of the goals of the facility management systems is to ‘satisfy end-users’ by providing an acceptable service level. Often, this includes some level of negotiation.

In the above example, although the Tenant needs a quick solution to his/her problem, he/she will have to accept the proposed schedule of work—especially, when to expect the technician at their location.

Also, a portion of the work may involve additional payment (according to contract terms), which will require some negotiation.

Prior Art Solutions

Contact Center

A common solution deployed in the industry for end-user interface with facility management is to use a ‘contact center’ to communicate between customer representatives (end-users) and facility management systems. When a Tenant calls the contact center to report an issue, the contact center operator would ask necessary questions to collect mandatory information in order to create the Work Order in facility management systems. Further, the contact center is also used to report the progress of work to Tenants and to collect feedback.

Web Portal

In some cases, certain parts of the workflow may be accompanied with a ‘web portal’ to reduce manpower involved in the contact center. For example, a portal may allow a Tenant to select a problem type and initiate a request, which is very similar to sending an email describing the issue. Upon receiving the basic request, a coordinator would speak to the Tenant (or reply to the email) and attempt to gather additional information necessary to create the transaction in facility management software.

When it comes to feedback collection, a separate email may be sent to the Tenant with a link to the web portal where Tenant is able to rate the work and provide additional feedback.

Time-Sensitive Situations—Such as Incident Management

Although the prior art could cater to general service requests, it is unable to handle progressive real-time data collection from multiple participants in time-sensitive situations—such as ‘incident management’.

Unlike the cost implication in a mishandled service request, incident management is associated with a high risk in life safety, liability and negative publicity. Collecting accurate information is extremely important before any action is taken because taking inappropriate action might be more damaging than not taking an action.

As a result, there could be multi-level decision making involved in qualifying a reported incident before it gets escalated, and also to choose the right action to resolve it.

The prior art does not address these problems.

### SUMMARY OF THE INVENTION

The present invention is a method and system for facility management personnel, technicians, security, tenants, visitors and other occupants of the facility to collaborate on matters relevant to management, operation, safety and repair of the facility.

According to a preferred embodiment of the invention, the system includes a mobile app installed on the mobile devices of a plurality of facility occupants which allows the facility occupants to communicate and collaborate with one-another concerning issues concerning the facility. The availability of the app will be made known to the Tenant during the lease negotiation process. Facility management personnel will be advised of the app when it is implemented by facility owners/management. Security personnel, contractors, etc., will be introduced to the app by facility management personnel. Shoppers, customers and other visitors to the facility may be apprised of the app by signs at the entrance to the facilities and at other high traffic areas. The app may be downloaded from an app store in the usual fashion. According to alternative embodiments, Tenants, shoppers and/or other visitors to the facility may access a pre-downloaded app at conveniently located kiosks.

According to a further aspect of the invention, a collaboration server is provided and configured to receive, deliver, coordinate, manage, and store communications from/among/between the mobile apps installed on user devices and to communicate with the facility management software.

According to a further aspect of the invention, there is provided a facility management software in communication with various facility infrastructure systems, including entry exit control, fire alert and control systems, lighting systems, video and audio recording systems; public address systems, HVAC systems, plumbing systems, electrical systems, phone systems, etc., as well as with the collaboration server. According to a preferred embodiment of the invention, the facility management software may be any facility management software which is already installed and/or which may be installed at a facility

According to a further aspect of the invention, there is provided a plurality of software translation scripts, each of which is specific to a particular facility management software product and which allows the collaboration server to communicate effectively and efficiently with each specific facility management software product.

According to a further aspect of the invention, the mobile app allows end users (Tenants, shoppers, visitors, security personnel, service technicians and facility management) to initiate a conversation concerning a situation that the end-user believes requires the attention of facility management, for example, the presence of smoke, a water leak, the presence of broken glass, a slip and fall, etc. Upon becoming aware of a situation that requires the attention of facility management and/or security, the user would open the app on her or her mobile device or at a nearby kiosk. The mobile app is configured to prompt the user to enter information that will allow facility management personnel and facility management systems software to categorize the type of incident, severity of the incident, location of the incident, response required, etc., and initiates a conversation with facility management by inviting appropriate facility management personnel to join the conversation to elicit additional information and/or provide instructions to the user. The mobile app communicates the information to the collaboration server which in turn alerts facility management personnel via the mobile apps loaded on their mobile devices. The collaboration server also communicates with the facility management system software via the appropriate script which in turn allows the facility management system to participate in the conversation and, optionally, take over management of the communications and response, if appropriate. As facility management personnel and/or the facility management system make decisions concerning the appropriate response, the app may be used to contact and/or instruct the appropriate persons (janitorial, on-site maintenance, off-site contractors, on-site security, police, fire and/or rescue) according to the required response. As the incident and/or situation continues to develop, feedback to/from and instructions to the user, to facility management personnel/system and responders may be communicated via the conversation that was initiated in the app by the user, while the facility management software catalogs and processes the information for decision making purposes, for performance and quality review, and for process improvement.

Accordingly, there is provided according to the invention, a system including a communications network, a collaboration server connected to said communications network containing collaboration software stored on an intransient medium containing computer readable instructions for: i. automated hosting of online conversations between a plurality of users and a facility management representative concerning a facility condition or other facility incident requiring facility management attention; ii. automated prompting said plurality of users to provide information specific to a selected conversation type; iii. automated receiving and storing of information from said online conversations without operator involvement, iv. automated transmitting of selected data from said conversations to said facility management representative without operator involvement; v receiving information from said facility management representative and transmitting it to said plurality of users via said online conversations; a mobile application installed on a plurality of user devices, said mobile application comprising software stored on an intransient medium containing computer readable instructions for: i. allowing said user's to participate in said online conversations with other users and with said facility management representative, wherein said user enters information concerning a facility incident or facility condition; and ii. transmitting said information concerning a facility incident or facility condition to said collaboration server; said collaboration software further containing computer readable instructions for delivering said information concerning a facility incident or facility condition to said facility management representative for managing a response to said facility incident or facility condition.

There is further provided according to the invention a system wherein the facility management representative is

There is further provided according to the invention a facility management server connected to said communications network containing facility management software stored on an intransient medium containing computer readable instructions for: i. receiving information via said communications network from said collaboration server concerning statuses of a plurality of facility incidents and conditions; ii. automatically generating work orders for the addressing a reported facility condition or incident without operator involvement based on information received from said collaboration server concerning said facility condition or incident which information the collaboration server received from said plurality of users participating in said online conversation, said work flow generated based on one or more pre-determined work flow templates.

There is further provided according to the invention a system wherein a user may request for a facility management service by starting said online conversation by opening said mobile application and choosing a conversation type from a list stored on said mobile application and presented to said user upon the opening of said mobile application, and wherein a list of conversation members are automatically added to the online conversation by the collaboration server which collaboration server notifies said conversation members inviting them to participate in the online conversation.

There is further provided according to the invention a system further comprising data collection fields stored in said collaboration server configured to receive structured data relating to a plurality of facility management response and service processes, such that when said data collection fields are completed with structured data relating to a facility management response or service process, said collaboration will send a request to the facility management server to automatically generate a work order for carrying out said response or service without operator involvement.

There is further provided according to the invention a system wherein participation of said facility management server is executed via an integration script stored on said collaboration server, and wherein said facility management server monitors the structured data placeholders in said collaboration server via said integration script, and wherein said facility management server is configured to automatically initiate work order generation when a predetermined amount of structured data placeholders for a particular response or service process without operator involvement.

There is further provided according to the invention a system wherein the integration script periodically updates the online conversation during facility management response after a work order has been generated to provide progress report to conversation members via said online conversation.

There is further provided according to the invention a system wherein said mobile app and said collaboration server are configured to receive data from conversation members in the form of digital photographs and digital audio files and automatically transfer said digital photographs and digital audio files to said facility management representative.

There is further provided according to the invention a system further comprising a checklist saved on said collaboration server and configured to guide members of said online conversation in providing information necessary to respond to facility management service requests.

There is further provided according to the invention a system further comprising a public kiosk comprising software stored on an intransient medium containing computer readable instructions for i. allowing said user's to participate in said online conversations with other users and with said facility management system, wherein said user enters information concerning a facility incident or facility condition; and ii. transmitting said information to said collaboration server.

There is further provided according to the invention a system in which said online conversation is initiated by said facility management server, said collaboration server automatically adding members to said online conversation and inviting said members to join said conversation via said mobile application installed on user devices according to predetermined user lists corresponding to a conversation type selected by said facility management server.

A more detailed description of the invention is set forth below with reference to the following figures.

### BRIEF DESCRIPTION OF THE DRAWINGS

FIG. 1 is a representation of the elements of the invention, including user devices having the mobile app, the collaboration server, and the facility management system, in communication over one or more wireless networks.

FIG. 2 shows an example of how a visitor to the facility might be notified of the mobile app according to an embodiment of the invention.

FIG. 3 shows an example of what an embodiment of the invention might look like on the home screen of a user's device.

FIG. 4 shows an example of an embodiment of the invention at a mall kiosk.

FIG. 5 shows an example of a screen that might be presented to a user upon opening an app according to an embodiment of the invention.

FIG. 6 shows the opening screen of FIG. 5, together with a next screen that might be presented if Tenant Peter had selected “AC Service” from the opening screen.

FIG. 7 shows an example of how a user might be notified that a conversation has been initiated to which he/she has been invited.

FIG. 8 shows an excerpt of conversation initiated by Tenant Peter in which Service Supervisor Joe B is participating concerning Tenant Peter's notification of a concern with the air conditioning, according to an unstructured messaging embodiment of the invention.

FIG. 9 shows an example of a structured data and info fields feature of the invention according to an embodiment of the invention, in which participants in the unstructured messaging conversation can select from various pre-programmed menu elements which correspond to the selected conversation type.

FIG. 10 shows an example of a screen which allows participants in the conversation to add attachments to the conversation.

FIG. 11 shows an example of a screen which allows participants to track the progress of incident response.

FIG. 12 shows an example of an embodiment of the invention according to which allows participants to identify locations of incidents, people or equipment for the purpose of efficient incident response.

FIG. 13 shows an example of an work flow according to which the collaboration server may work with the facility management system software to collect the information necessary to respond to an incident report using the collaboration system of the invention.

FIG. 14 shows another example of a work flow according to which the collaboration server may work with the facility management system software to collect the information necessary to respond to an incident report using the collaboration system of the invention.

### DETAILED DESCRIPTION

Collaboration Through Conversation

This invention provides a collaborative tool for facility management data collection, information exchange, decision making, action instructions for incident response through on-line live conversations using a collaboration server, facility management software/system/server, a mobile app installed on the mobile devices of facility management personnel, tenants, janitorial providers, maintenance personnel, security personal, outside contractors, police, fire and rescue personnel, and visitors to and guests of the facility.

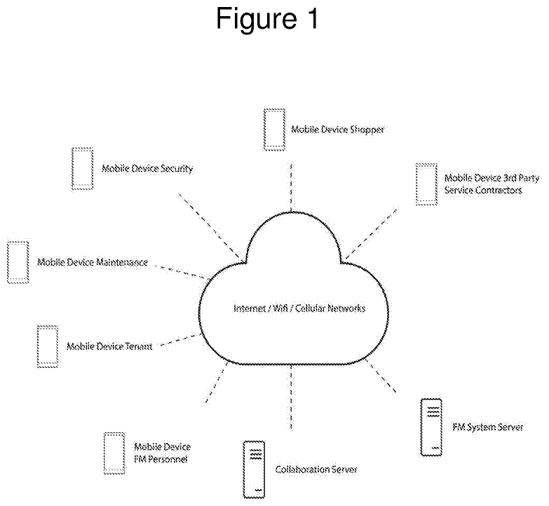

Referring to FIG. 1, the invention connects facility management software, facility management personnel, facility tenants, facility security personnel, facility maintenance/janitorial personnel, and facility visitors (e.g., shoppers, clients, etc.), in online collaborative conversations for managing and executing efficient response to facility incidents using the collaboration server and facility collaboration mobile apps installed on user mobile devices communicating with one-another in real time over wi-fi and/or cellular networks using standard communication protocols in a way that allows the participants to collaborate using their mobile devices to provide detailed information concerning an incident that permits efficient and effective facility management response to the incident.

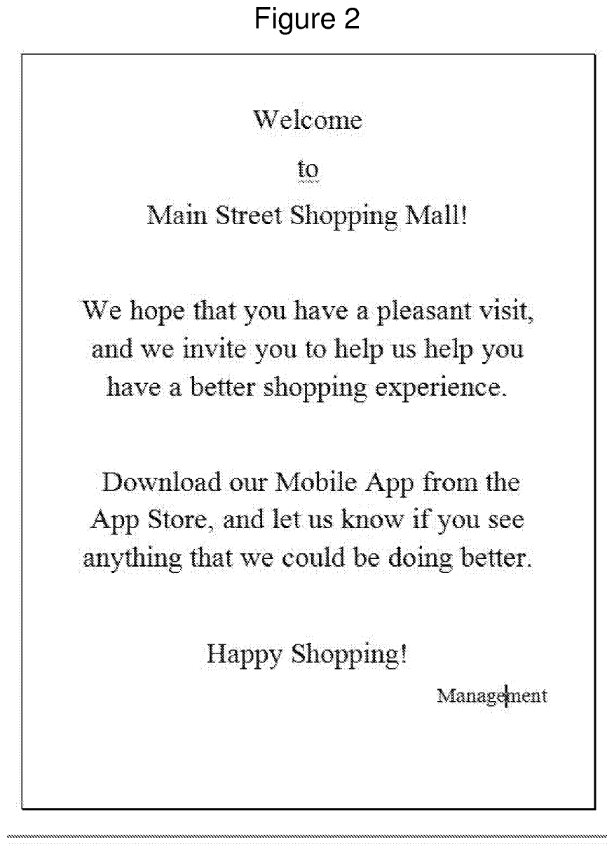

Facility management personnel will be advised of the mobile app and its use when the collaboration system of the invention is implemented by facility owners/management. Security personnel, contractors, etc., will be introduced to the mobile app by facility management personnel. The availability of the app will be made known to the Tenant during the lease negotiation process. Shoppers, customers and other visitors to the facility may be apprised of the app by signs at the entrance to the facilities and at other high traffic areas. According to one example, visitors to the facility might be greeted with a sign that reads: “Welcome to the Main Street Shopping Mall! We hope that you have a pleasant visit, and we invite you to help us help you have a better shopping experience. Download our Mobile App from the App Store, and let us know if you see anything that we could be doing better. Happy Shopping!” See FIG. 2.

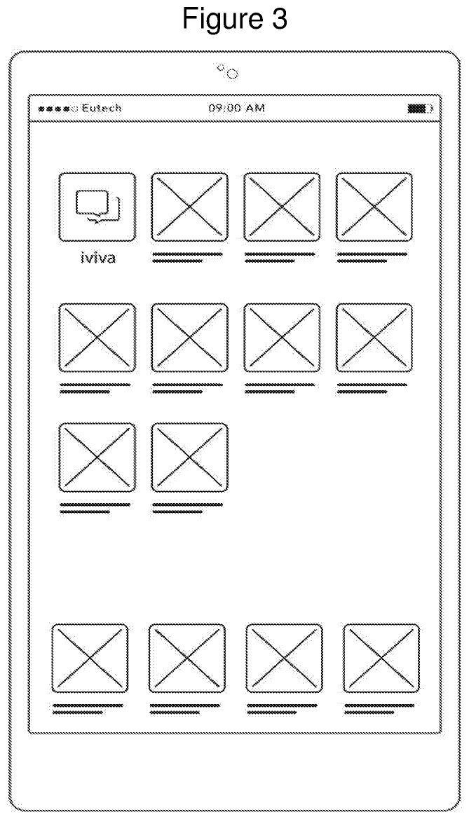

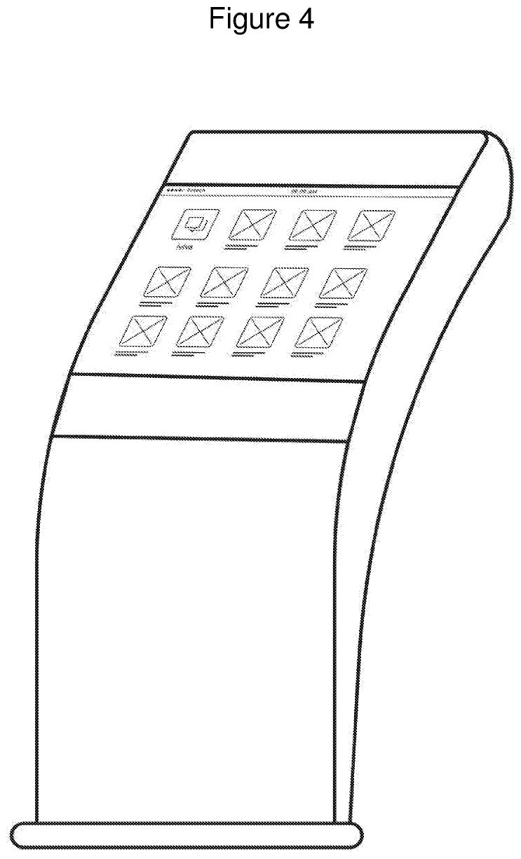

The app may be downloaded from an app store in the usual fashion. An example of what the mobile app might look like to users is shown at FIG. 3. According to alternative embodiments, Tenants, shoppers and/or other visitors to the facility may access a pre-downloaded app at conveniently located kiosks, see FIG. 4.

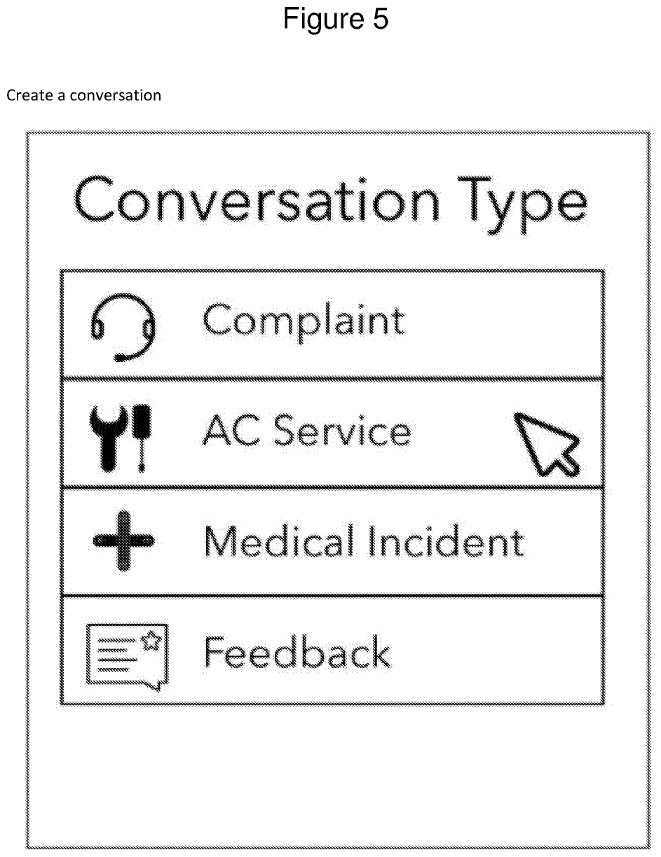

When a user (for this example, a Tenant) first opens the app, he/she is asked to register with an email, username and password. Registration is only required the first time the user opens the app. Once registered, the user is asked to login with the username and password. Once logged in, the user is presented with a screen showing a list of ‘conversation types’ from which to select, see FIG. 5, reflecting various reasons/scenarios that might be the cause for a user to interface with facility management and various situations that facility management might want to be made aware of. In this example, a Tenant believes that the air conditioning system may not be working properly. Accordingly, after logging on the app of the invention using his/her mobile device, he/she might select the “A/C Service” conversation. The opening screen can have a list of dozens of different pre-programmed “conversation types” only some of which may be listed on the opening screen, and the app may be set up to allow the user to scroll down or swipe left/right to access other conversation types representing various different ‘reasons’ to initiate a Conversation.

Once the user selects a conversation type, the mobile app communicates the selection to the collaboration server and the collaboration server advises the facility management system software accordingly and invites pre-selected users to join the conversation according to the selected conversation type. The pre-selected lists of user responders for each conversation type/situation may be stored in the app, in the collaboration server, or in the facility management system. For example, HVAC personnel might be invited to an A/C service selection according to pre-programmed user responder lists. EMT personnel might be invited to a Medical Incident service selection, according to pre-programmed user responder lists. Supervisors and coordinators may be invited to the conversation as well, again, according to pre-programmed user responder lists.

Members of Conversation

As indicated above, according to one embodiment of the invention, each conversation type has a pre-configured list of users or “response team” that are alerted and invited to join a conversation when a conversation of that type is initiated. The pre-configured response teams for each conversation type can be manually configured by facility management personnel when the system is set up, or it can be configured by the facility management system software, or it can be configured by some combination thereof. As mentioned above, the response teams for each situation/location may be pre-programmed and stored in the mobile app, in the collaboration server and/or in the facility management system. Participants in a conversation may sometimes be referred to herein as “Members,” and each member has a specific role in the conversation. The user who initiated the Conversation becomes the Requestor Member of the Conversation, or simply Requestor.

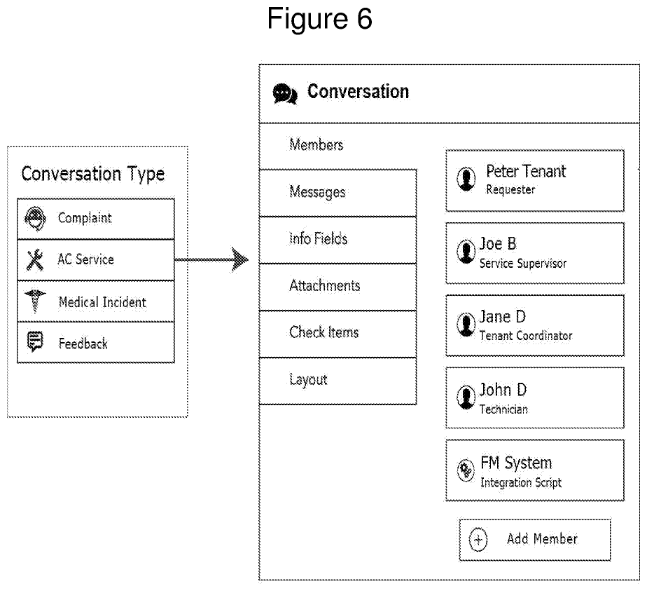

In the case of a Conversation Type of ‘air conditioning service,’ the system may be configured to initially assign specific persons to the roles of a ‘Service, and ‘Tenant Coordinator’, etc. FIG. 6 shows the screen that might be displayed according to an invention if the members tab is selected following a user/Tenant selection of an AC Service Conversation type. Optionally, after selecting the conversation type, the user may be prompted to select a Location from a list. This allows the system to automatically determine the appropriate response team, for example, the ‘Service Supervisor’ responsible for air-conditioning services for that specific location and the technician responsible for effecting A/C repairs at that location. The ‘Tenant Coordinator’ may be pre-selected/ based on the location and/or it may be tenant-specific.

As shown in FIG. 6, Peter Tenant is the requester, Joe B is the pre-programmed service supervisor for AC Service at the selected location, Jane D is the pre-programmed tenant coordinator for this tenant, John D is the AC technician pre-programmed for this location, and the Facility Management system is also a member of the conversation in order to coordinate response work flow.

In addition, any participant can request that another user be added to the conversation by selecting the “+ Add Member” button.

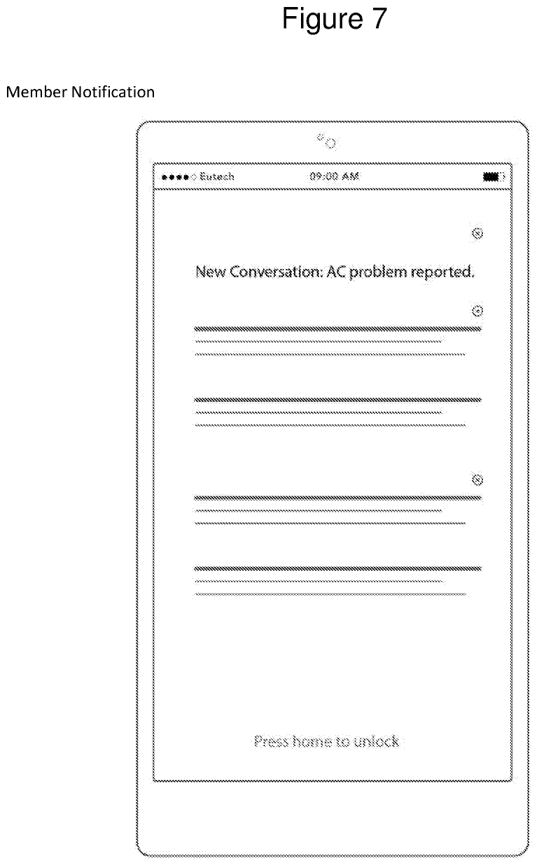

When a particular user is made a Member of a Conversation, he/she is notified through the mobile app about the newly assembled conversation and invited to join the conversation through the app. FIG. 7 shows what a user notification might look like on a mobile device when it receives a conversation invitation.

Unstructured Messaging

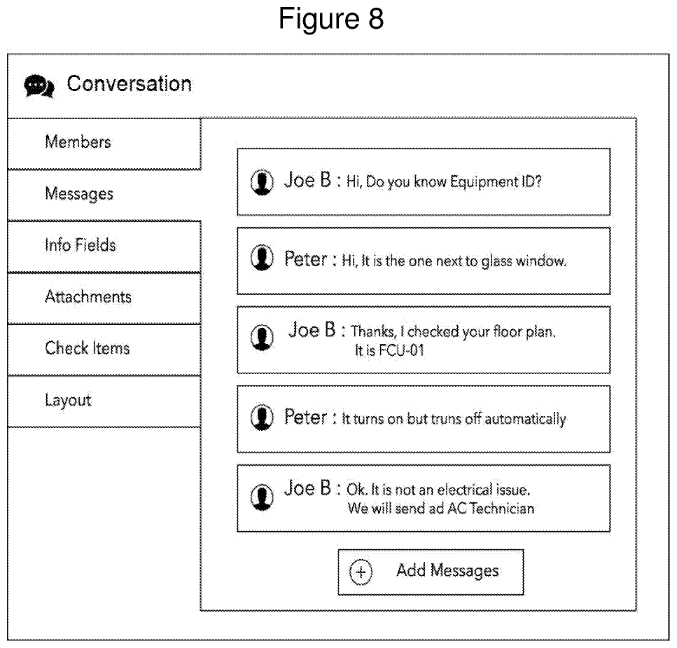

FIG. 8 is a representation of unstructured messaging available to users on the facility management collaboration mobile app, which may be optionally established as the default/initial conversation type. According to this embodiment, once a user has selected a conversation type, the invention may immediately welcome the user, thank the user for using the app, and invite the user to describe the problem via a text/sms-style message (but not using sms protocols/technology). In the meantime, the system is inviting pre-programmed participants to join the conversation and waiting for them to begin participating via the mobile app installed on their respective mobile devices. If user members do not immediately join the conversation, the system may preferably begin to prompt the user under the direction of the collaboration server to provide additional details concerning the incident (such as location, etc.) according to automated scripts and/or under direction from the facility management system software which may be following a specific work-flow template for incident response. In order to type a message, a user need only press the “+Add Messages” button and a typing field will appear allowing the user to type the next message. In any event, participants in the conversation (“Members”) are able to post Messages for all Members to see, in a form of a casual chat. This enables a free form of collaboration and information exchange between the Members of the Conversation.

During the conversation, the collaboration server and/or the facility management server are preferably monitoring the conversation and collecting information necessary to complete a work order template for the required repair/response and scanning the conversation for information that has yet to be provided based on work order template requirements/data fields. If the system does not recognize that certain information has not been provided after a certain period of time, the invention system can submit a message to the conversation via the collaboration server asking for the missing information. According to a different embodiment, the facility management system can run the conversation, asking for all the required information at the outset, while other invited members are still joining the conversation.

Since one objective of the Conversation is to collect necessary data such that backend Facility Management system might act on it, i.e., develop a work order/work flow for addressing the problem/situation which prompted the conversation, the collaboration server must convert the information contained in the user messages (such as ‘air conditioning problem’) into structured data (such as ‘Service Category=HVAC’). Structured data requires two parts: a well-known placeholder (‘Service Category’) and well-known data identifier (‘HVAC’). Since both supplying software (this invention) and receiving software (FM system) is familiar with them, such data is machine-readable—i.e.: receiving software is able to correctly interpret what it means without operator involvement.

Structured Data

Accordingly, the present invention provides for the capture of data in a structured fashion, which provides for accountability for input data, reduces ambiguity and makes it machine readable.

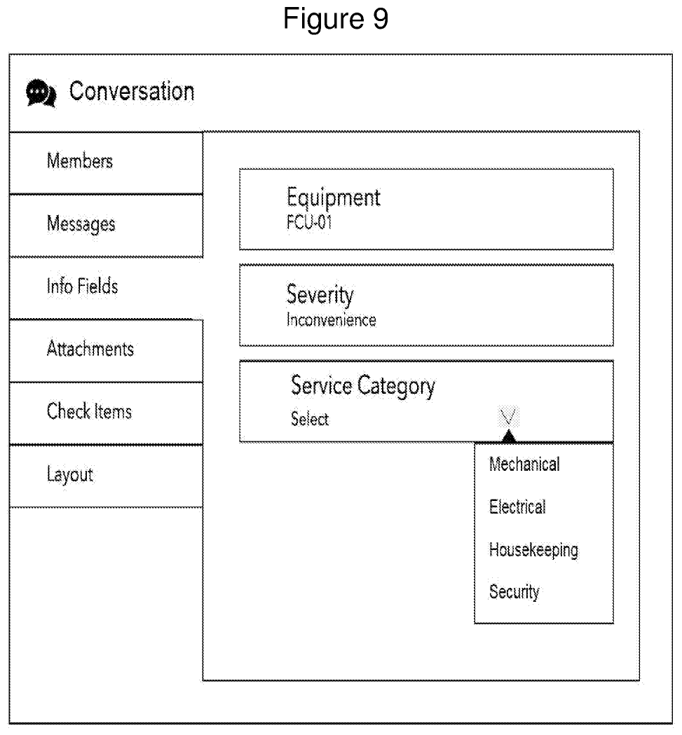

According to this embodiment, the user may select, or be directed by a conversation member (including the facility management system), to select the “Info Field” tab on the app which selection will bring up several drop down data fields relating to the substance of the conversation, such as “equipment” and “severity” and “service category.” See FIG. 9. The data fields might be configured to vary from conversation type to conversation type, depending on the type of structured data required for the facility management system to build an appropriate response work flow. The system may also be configured to allow users to toggle back and forth between the messages tab of the conversation and the Info Field tab so that the conversation is a hybrid of structured and unstructured data.

Info Fields

This invention allows Conversation to have ‘Info Fields’ (specific placeholders to carry structured data) where collaboration server would provide list of suitable data items to choose from. If the Requester is able to identify them, he/she could. Otherwise, he/she would describe the location as “it is the one next to the window”. Another Member of the Conversation, such as the Service Supervisor, could determine the actual equipment based on the location description by the Requester, and select it in the Info Field.

Layout

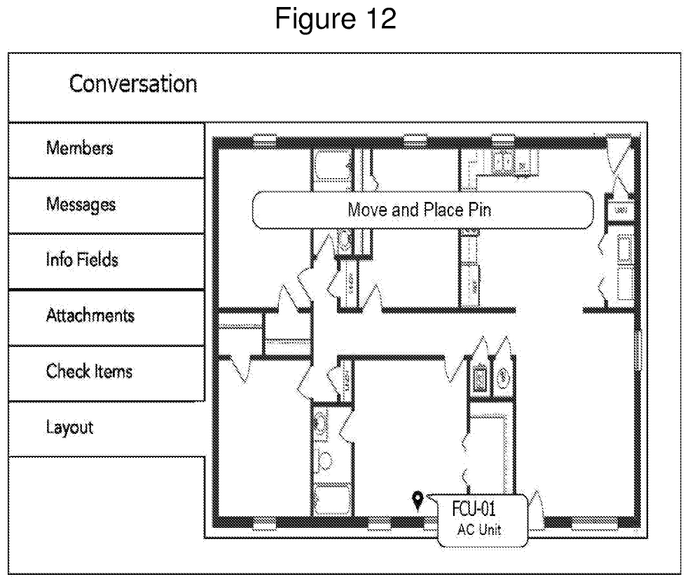

According to another structured data feature of the invention, the invention may allow a user to identify the specific location of the incident/problem by selecting the “Layout” tab on the app, see FIG. 12. The app may optionally determine an initial/gross location by accessing the mobile device's location/gps capabilities or by an identification of the location by the user in the unstructured messaging. In any event, upon selection of the “Layout” tab by the user, the collaboration server may cause the user's mobile app to display a floor plan of the general location. The app may allow the user to navigate left, right, up and down, as well as zoom in and out, on the floor plan and to place/move a pin (similar to how a dropped-pin is placed in mobile phone maps) to indicate the exact Location that the Conversation represents. This is useful in situations where the Requester is not able to identify the equipment in question. As described under Info Fields above, another Member may use the Layout tab to assist the Requester in making the right choice in equipment selection.

In some cases, such as when reporting an incident, the request may involve any equipment, where the Requester (or any other Member) is able to ‘mark’ the Location in question on the Layout for other Members to see.

Check Items

According to a further optional feature of the invention, the mobile app may allows the system or a Member to introduce ‘check items’ (as a checklist) where a Member is able to ‘mark’ certain tasks as completed. According to this embodiment, a Check Items tab can act as a ‘to do list’ for the collection of structured data to complete a work order. When a Conversation is created by the collaboration server based on a Requester's initiation, the collaboration server can enable a Check Items tab in the mobile app and add the necessary steps from a corresponding work order template as Check Items. For example, in the example discussed previously, a check items task list might include: (a) Identify Severity, (b) Place a Pin on Layout, etc., in effect acting as ‘to do list’ for Members of Conversation to remind tasks to be performed to collect necessary data, When the task is done, a Member will mark it as done in the Check Items screen of his mobile app.

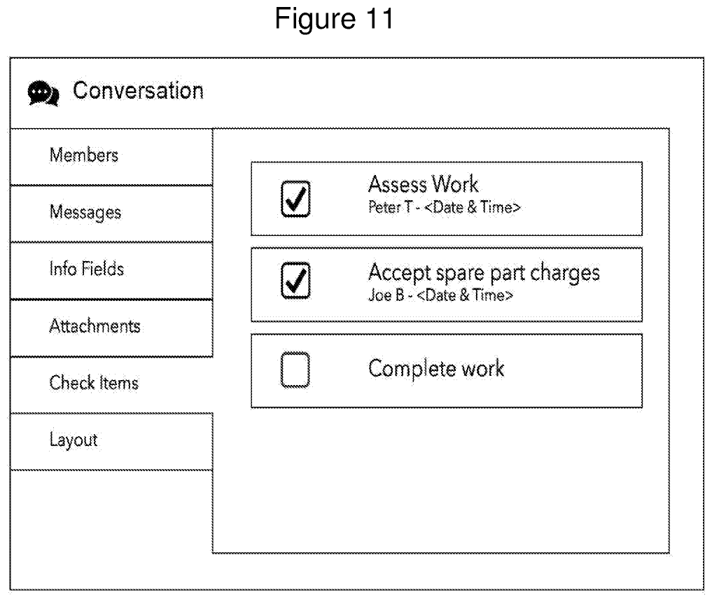

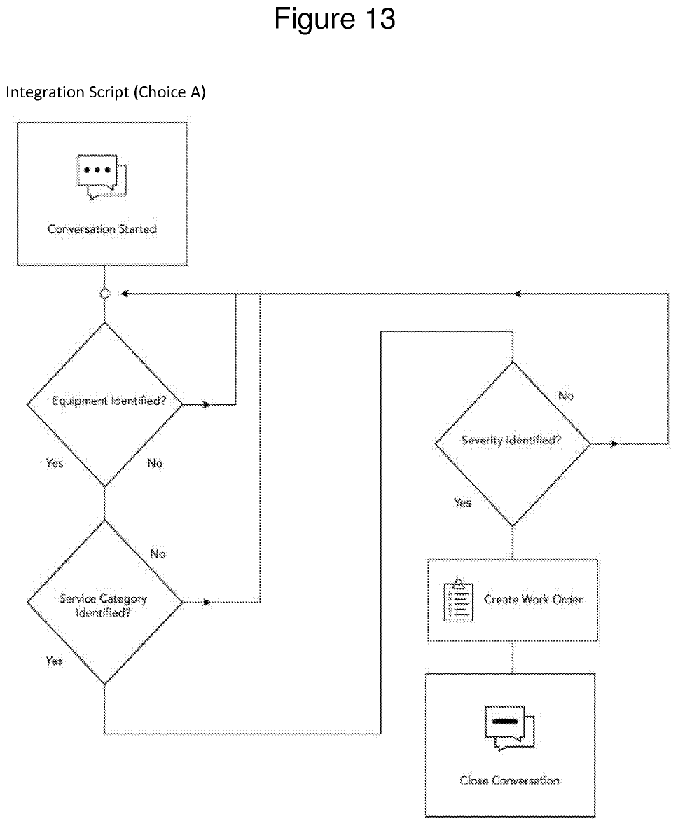

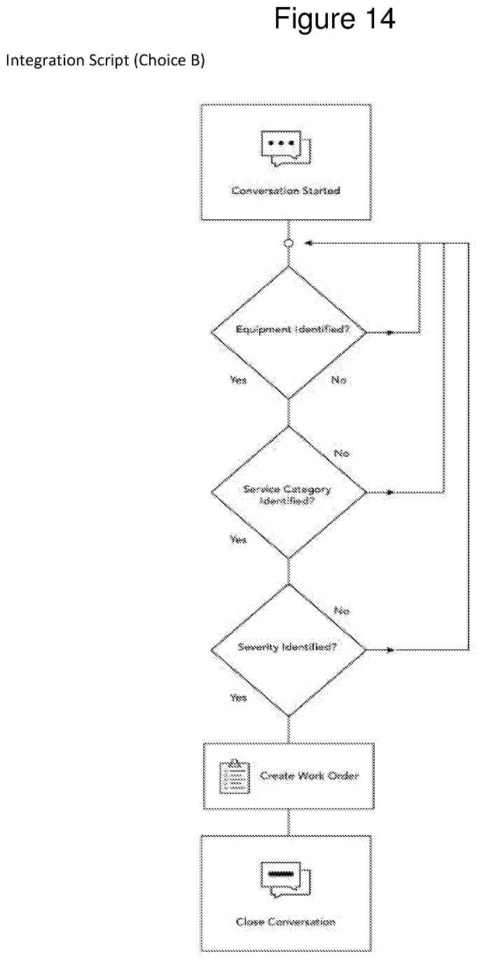

FIG. 11 is a representation of how a user can check and uncheck items in the mobile app. According to an alternate embodiment of the invention, in which the facility management system is not automatically invited to the Conversation, the Check Items feature of the invention can act as a trigger to ‘wake up’ the facility management system and cause it to join the Conversation in the event a certain incident/conversation meets one or more pre-set thresholds. For example, a Conversation may be created to identify an incident. First responders who are enabled in the Conversation would ask questions and collect facts to determine whether it is a serious incident that needs action or something that can be dismissed. When they determine it is a serious incident, they could mark ‘Escalate Incident’ Check Item as done, which will enable Integration Script (See FIGS. 13 and 14) in collaboration server to send a command to FM system to initiate a transaction (Incident Report in this case) to manage the incident.

Attachments

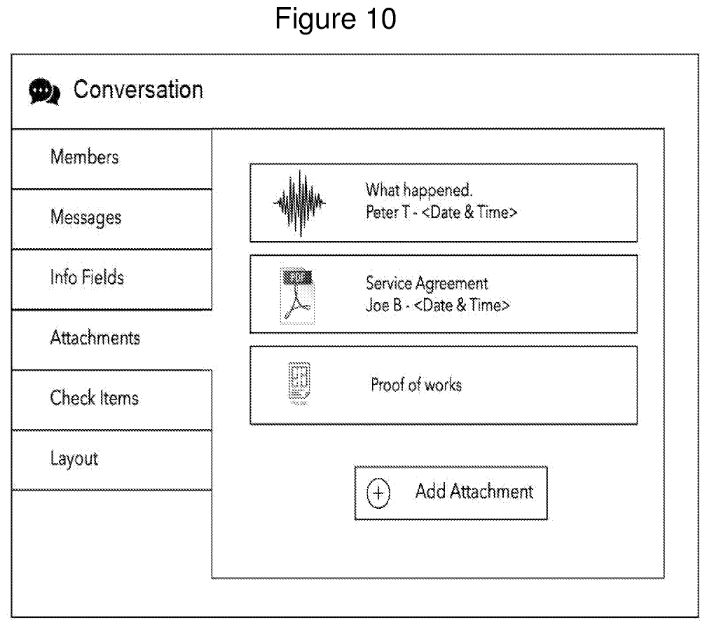

According to yet additional alternative and optional features of the invention, the mobile app may be configured to present an “Attachments” tab (See FIG. 10) which, upon selection by a user, allows a user to attach, for example, photographs, audio files, documents, etc. which may be useful for the other Members to understand the circumstances of the incident and/or to provide information to the facility management system for building of a work order. The attachments might then be available to the Members for viewing using their mobile apps. Thus, Members of the Conversation might take one or more photographs to define a problem more accurately, or record an audio clip in the case in which it is difficult to explain the problem in written words or pictures.

The Service Supervisor might then use the attachments to determine the ‘Severity’ of the situation, which is another important factor to know before work is scheduled.

The feature might also be used by a service technician to show the state of the problem and/or to prove that the required service has been completed.

Inviting Outside Providers to the Conversation

### (Contractors/Police/Fire/Rescue)

As described above, the invention has the capability of expanding the conversation beyond the initial user and the facility management system/personnel by (allowing facility management personnel/software to) inviting/(invite) third parties to join the conversation, as appropriate. In the case of a repair that is beyond the ability of on-site maintenance, an invite may be sent to a preferred HVAC, plumbing, electrical, etc., provider whose technicians have the app of the invention installed on their mobile devices. In the case of a requirement for emergency providers, an invite might be sent to police, fire and/or rescue personnel who have been asked to download and install the app of the invention on their mobile devices.

In the above example, the Service Supervisor may need to consult an air-conditioning expert to determine the necessary skills to repair this equipment. In that case, he/she will introduce a new Member, ‘consultant’, into the Conversation where he/she will be able to refer to existing information within the Conversation to make a proper assessment.

In this case, the Consultant may want to know whether the equipment is making any noise, to make a better judgement of the cause. Accordingly, the consultant, having been invited to the Conversation, might re view the past message, determine that this question has not been addressed, and then post a Message asking the question, and the system will notify all Members about it, including the Requester, who will be able to reply to it.

If necessary, the Consultant may even post an image from his photo gallery and ask the Requester to confirm whether the situation is similar to that image.

User Rights Restriction

As one purpose of the invention is to collect structured data (and/or collect unstructured data and convert it to structured data) and pass it to the facility management system, it might be preferred according to some embodiments to limit the ability of some users to to enter data into certain Info Fields, for example, limiting the ability to mark Check Items as completed to only Members having authority. For example, the system might be configured to prevent a Requester from specifying Severity Info Field in certain Conversations because the Requestor's assessment of Severity will be from his/her point of view whereas the purpose of Severity for the facility management system is to determine priority order of work in hand. Accordingly, the present invention might be configured to restrict the ability of different users to view or edit certain Structured Data elements based on each user's Member Role.

Two-Way Interfacing with Facility Management Software

According to various embodiments of the invention, the system may be configured so that the facility management system begins to automatically build a work order as information/data is collected from a Conversation, or it may be configured so that the facility management system does not take action until it is requested to do so by the collaboration server. According to this embodiment, the system may be configured to allow the Service Supervisor or any other Member with authority to activate an Integration Script (in the collaboration server) by marking a Check Item as done to cause the facility management system to generate the appropriate Work Order.

As discussed above, the invention might be configured so that the facility management system is made a part of the Conversation as a virtual member by the collaboration server, based on the Conversation Type chosen when the Conversation is created. Just as each Member of Conversation would receive the notification when some activity takes place in the Conversation, the facility management system, acting as a participant in the Conversation, will receive notices to keep track of the progress of the Conversation. When the facility management system has identified all necessary Structured Data necessary to create the Work Order, it would automatically create it. Alternatively, the facility management system can begin building the Work Order as information relevant to the appropriate Work Order is transmitted to the facility management system.

After the facility management system has created the Work Order, the Conversation might be maintained for the participants/Members to receive feedback about the progress of work. Alternatively, the Conversation may be closed, based on a decision by a Supervisor, or based on work flow/Integration Script carried out by the collaboration server. In another embodiment, the collaboration server may remove the Requester from the Conversation and continue Conversation for coordinating the work.

Integration Scripts

As the collaboration server is in most instances likely to be different from the facility management server, effective communication between the collaboration server and the facility management server is necessary. According to one embodiment of the invention, this communication is carried out by one or more Integration Scripts configured to standard web-service protocol to push and pull information between two servers based on predetermined workflows.

Simple Use Case

According to one embodiment of the invention, the various data fields and relationships necessary for the facility management server to generate work orders for various tasks/responses is stored on the collaboration server. According to this embodiment, for example, the list of Info Fields and list of Members (dynamic team) may be identified by a fixed configuration, based on Conversation Type—Air conditioning service, in this case.

Further according to this embodiment, the Integration Script is configured to cause the collaboration server to collection information relevant to the appropriate work order and communicate it to the facility management server with instructions to generate the work order once all the relevant information has been collected.

Complex Use Case

According to a different embodiment, the Integration Script generates a virtual Member in the Conversation representing the Facility Management server, and introduces questions into the conversation on behalf of the facility management server relating to work order fields that are required for a work order/response to the Conversation. In this case, depending on the complexity/sophistication of the facility management server, the Integration Script may send the data collected from the Conversation as it is collected and introduce questions to the Conversation if and when prompted by the facility management system, for example in the case where a data field is missing from a work order that the facility management system is in the process of generating.

In short, the Integration Scripts account for the different levels of sophistication of different facility management systems, and effectively act in the place of the level of direct human interaction required for a particular facility management system, allowing the collaboration server to coordinate both the collaboration between the various human users and with the facility management server.

In this regard, as a Work Order progresses from one ‘stage’ to another, facility management systems may update the progress in a corresponding Conversation via Integration Script.

Using Conversation for Service Coordination

The invention also provides for continued communication and collaboration where additional information is be required for coordinating the service.

For example, a technician who is dispatched to the site to conduct the repair may determine that some spare-parts are required to fix the equipment. In a situation where only the service fees are covered by the existing contract between the facility and the tenant and spare-parts are chargeable to tenant/Requester, the Technician may use the mobile app of the invention to type a message into the Conversation to indicate that spare parts are required and introduce a Check Item to the Conversation to “accept spare part charges” in which case the Requester/tenant would be required to ‘mark’ the “Check Item: Spare Parts Required” to accept responsibility for the cost of the spare parts.

Additionally, if the facility management system requires this input for the ordering of spare parts from the store, the Integration Script will recognize it and update facility management systems as ‘Requester accepted charges.” This type of transaction is not possible without structured data such as Check Items.

Conversation Type—a Template

The Collaboration server maintains its knowledge to create the Conversation with necessary Members, Info Fields, Check Items and Layout using a Template specific to each Conversation Type. In addition, each Template will determine suitable data options for each Info Field for Members to choose from. For example, list of Severities to be shown for Severity Info Field.

Passive Templates

According to one embodiment, the Template may be a passive data structure, which simply lists out a list of Users who should be added to the Conversation based on the selected Conversation Type. In the above example, it might be a data structure as follows:
[Initiator]=>Requester
Joe B=>Service Supervisor
Jane D=>Tenant Coordinator
facility management systems=>Integration Script

Similarly, the collaboration server adds Info Fields, Check Items and Layout as specified in the Template. Passive Templates will also carry options to be offered for Info Fields, such as list of Service Categories and Severities.

Active Templates

In another embodiment, instead of specifying a list of absolute User, a ‘relationship’ may be specified to determine the dynamic team at the time of initiating the Conversation.

According to this embodiment, the data structure might be as follows:
[Initiator]=>Requester
[facility management systems supervisor of Tenant's location]=>Service Supervisor
[Coordinator of Tenant's leasing contract]=>Tenant Coordinator
[Service Category]=>Integration Script.
   This is to accommodate situations where multiple ‘service management’ software is used for different service categories.
The collaboration server processes the instructions in Active Template to determine exact list of Users to enable as Members for the Conversation.

Progressive Templates

In the case of both passive and active templates, it is possible to expand the Conversation data structure progressively. In some situations, such as the scenario explained above in ‘Inviting Outside Providers to the Conversation’ section, it may be necessary to expand the Conversation structure dynamically. This is accomplished by the Integration Script, which carries the programming logic to add new Members. In the scenario mentioned, the Integration Script will communicate with the backend facility management system to determine who is the external vendor assigned to the Work Order and add him/her as a Member.

In another embodiment, the Integration Script may add a new Check Items relating to attending to the request, such as ‘Call Customer to Schedule’ and ‘Job Completed?’, after Work Order is created in FM system. When the Vendor has marked ‘Job Completed?’ Check Item as done, Integration Script will communicate with FM system to complete the Work Order. Further, Integration Script may add a new Check Item ‘Job Satisfactory?’ to collect feedback from the Requester after Work Order has been completed.

Further Use Cases

The following are some of the use cases that the prior art is unable to fulfill without developing and implementing bespoke solutions, on a case by case basis.

Incident Reporting

With incident reporting, proper information needs to be collected and validated before it is considered as an ‘incident’ to be acted upon.

Also, incident reporting is time sensitive. There is no time for someone to enter data into a computer system and have the system validate information. The best approach is the collection and validation of data by a group of people, on the fly.

Another situation in incident reporting is that multiple people may report the same incident. It would be resource consuming to carry on individual discussions with each of them. On the other hand, it is would be discouraging and counterproductive to dismiss them, which might mask some important information they wanted to share.

With this invention, it is also be possible to add new incident reporters into an existing Conversation allowing multiple reporters to review what has already been reported/discussed concerning the incident, and to contribute any new information they have.

Emergency Evacuation

This invention also allows the ‘system’ to initiate Conversations. One of the use cases would be ‘emergency evacuation’. Instead of relying on broadcasting a message to everyone to evacuate, the system could also auto-initiate Conversations with each person known to be in the building, based on security and attendance systems. Alternatively, Conversations may be created for only users with special needs.

If any user requires special assistance, they could make a request. Once they reach the assembly point, they could mark the Check Item, ‘Safe’ thereby the system will be able to generate a ‘no show’ list where operators need to individually check them for.

User Journey Analytics

This invention keeps track of each action taken by Members (including both Users and Integration Scripts) in the form of an audit trail. This allows big data analytics to analyze user behavior with respect to ‘user journey’—what is the path user has taken to interact with the system.

1. A system comprising:
A. a communications network,
B. a facility management server connected to said communications network containing facility management software stored on an intransient medium containing computer readable instructions for:
i. storing work order templates for addressing potential facility conditions and potential facility incidents;
ii. receiving, storing and processing reported information relating to a plurality of reported facility condition and reported facility incidents;
iii. generating actual work orders for addressing one or more of said reported facility conditions and reported facility incidents based on said work order templates and based on said reported information;
C. a collaboration server connected to said communications network containing collaboration software stored on an intransient medium containing computer readable instructions for:
i. automated hosting of online conversations between a plurality of users and said facility management server concerning said plurality of reported facility conditions or specific reported facility incidents requiring facility management attention;
ii. storing and accessing data fields necessary for said facility management server to generate said actual work orders;
iii. automated prompting said plurality of users to provide information specific to a selected conversation type based on said data fields;
iv. automated receiving and storing of information from said online conversations without operator involvement
v. automated transmitting of selected data from said conversations to said facility management server without operator involvement;
vi. receiving information from said facility management server and transmitting it to said plurality of users via said online conversations;
D. a mobile application specific to said collaboration software installed on a plurality of user devices, said mobile application comprising software stored on an intransient medium containing computer readable instructions for:
i. allowing said users to participate in said online conversations with other users and with said facility management server, wherein said user enters information concerning said reported facility incident or reported facility condition; and
ii. transmitting said information concerning said reported facility incident or reported facility condition to said collaboration server;
E. said collaboration software further containing computer readable instructions for delivering said information concerning said reported facility incident or reported facility condition to said facility management server for managing a response to said reported facility incident or reported facility condition
F. said facility management software further containing computer readable instructions for:
i. receiving information via said communications network from said collaboration server concerning statuses of a plurality of facility incidents and conditions;
ii. automatically generating work orders for the addressing a reported facility condition or incident without operator involvement based on information received from said collaboration server concerning said facility condition or incident which information the collaboration server received from said plurality of users participating in said online conversation, said work flow generated based on one or more pre-determined work flow templates.

2. A system according to claim 1, wherein a user may request for a facility management service by starting said online conversation by opening said mobile application and choosing a conversation type from a list stored on said mobile application and presented to said user upon the opening of said mobile application, and wherein a list of conversation members are automatically added to the online conversation by the collaboration server which collaboration server notifies said conversation members inviting them to participate in the online conversation.

3. A system according to claim 1, further comprising data collection fields stored in said collaboration server configured to receive structured data relating to a plurality of facility management response and service processes, such that when said data collection fields are completed with structured data relating to a facility management response or service process, said collaboration will send a request to the facility management server to automatically generate a work order for carrying out said response or service without operator involvement.

4. A system according to claim 1 wherein participation of said facility management server is executed via an integration script stored on said collaboration server, and wherein said facility management server monitors the structured data placeholders in said collaboration server via said integration script, and wherein said facility management server is configured to automatically initiate work order generation when a predetermined amount of structured data placeholders for a particular response or service process without operator involvement.

5. A system according to claim 4, wherein the integration script periodically updates the online conversation during facility management response after a work order has been generated to provide progress report to conversation members via said online conversation.

6. A system according to claim 1, wherein said mobile app and said collaboration server are configured to receive data from conversation members in the form of digital photographs and digital audio files and automatically transfer said digital photographs and digital audio files to said facility management representative.

7. A system according to claim 1, further comprising a checklist saved on said collaboration server and configured to guide members of said online conversation in providing information necessary to respond to facility management service requests.

8. A system according to claim 1, further comprising a public kiosk comprising software stored on an intransient medium containing computer readable instructions for:
allowing said user's to participate in said online conversations with other users and with said facility management system, wherein said user enters information concerning a facility incident or facility condition; and
transmitting said information to said collaboration server.

9. A system according to claim 1, in which said online conversation is initiated by said facility management server, said collaboration server automatically adding members to said online conversation and inviting said members to join said conversation via said mobile application installed on user devices according to predetermined user lists corresponding to a conversation type selected by said facility management server.
